(19) United States
(12) Patent Application Publication
(10) Pub. No.: US 2014/0266590 A1
(43) Pub. Date: Sep. 18, 2014

(54) Reconfigurable Smart Identification Badges

(71) Applicant: NAGRAID SECURITY, INC., LOS ANGELES, CA (US)

(72) Inventor: PHILIPPE GUILLAUD, LOS ANGELES, CA (US)

(73) Assignee: NAGRAID SECURITY, INC., LOS ANGELES, CA (US)

(21) Appl. No.: 14/042,650

(22) Filed: Sep. 30, 2013

Related U.S. Application Data
(63) Continuation-in-part of application No. 13/830,341, filed on Mar. 14, 2013.

(51) Int. Cl. G07C 9/00

(52) U.S. Cl. CPC G07C 9/00111
USPC 340/5.65; 340/10.6; 340/8.1

(57) ABSTRACT

This invention provides a smart badge having a processor connected to a viewable display where both the processor and the display are embedded in the smart badge. The embedded components may be powered by an embedded battery or by RF energy generated by a smart badge reader. The badge can be uploaded with a digital image of the badge holder and predetermined criteria uploaded into an embedded memory location in the smart badge. Such predetermined criteria may include the name and contact information of the badge holder as well as the buildings or secure areas the badge holder is authorized to access. The smart badge may also be capable of generating secure codes for the badge holder to use as pass codes for accessing computer networks. The smart badge may also contain embedded location sensors that when merged with maps stored in the smart badge's memory can assist the badge holder in determining location.

### CLAIM OF PRIORITY

This application claims priority to U.S. patent application Ser. No. 13/830,341 filed on Mar. 14, 2013 titled “Dynamically Allocated Security Code System for Smart, Debit and Credit Cards” and is incorporated by reference.

### BACKGROUND OF THE INVENTION

1. Field of the Invention

This invention concerns the field of re-useable smart identification badges in use by employers to identify authorized workers, contractors and visitors and use as authentication passes to gain access to sensitive areas. Specifically, a smart identification badge is generated by uploading information about the smart badge holder. The smart badge can have its data wirelessly configured, updated or rights terminated by the transmission of data over a wired or wireless network.

2. Related Art

With today's security concerns, many buildings and secure areas require identification badges for employees, contractors and visitors to gain access to the building or a specific set of buildings. In some instances, identification badges may be implemented to access specific building floors, rooms or areas of a building further enhancing access to sensitive areas only by individuals having authorization.

Many organizations are now issuing badges to perform the identification function as well as performing additional functionality such as time entry and exit of a building or secure area. Access badges can be integrated with access control systems for office buildings, restricted areas, and even company computers and networks. The benefits of this type of access control are many. For example, a corporate workplace may employ both full time and temporary contract workers and require them to access the buildings and computer networks by using their identification badges. By integrating employee IDs with access control functionality, the badges can be activated and disabled as workers come and go. When a temporary worker's contract comes to an end, the badge can simply be deactivated denying that worker access to work areas, buildings or computer networks.

There are several different technologies used for badge based access control systems. Magnetic stripe cards stores secure information encoded on a magnetic strip. By sliding the badge through a special reader, an employee can gain entry to specific buildings and designated areas. Another highly popular method utilizes proximity or “RFID” technology. With proximity cards, the information is embedded in a memory location contained within the card and the cardholder must simply waive the card within range of a card reader. The system can be designed so that specific workers are able to gain access to certain buildings and areas that require authorization. When it comes to controlling access to computers and networks, smart cards are an excellent option. Typically, these cards contain information on a smart chip embedded into the card. The employee inserts the card into a card reader connected to the computer in order to log in and gain access to the organization's network or the card generates a continually changing PIN code that the user enters as a password to enter a secure computer system. Such technology is often used for organizations where workers must log in remotely. This allows employees from various locations to access the same network.

Newer prior art badges can log employees and contractors into an organizations payroll system. When the smart badge holder enters into a building or specific area, the smart badge is read by a card reader and the information is uploaded into the organizations computer network and the entry and exit times are logged into a database for retrieval by the organization's payroll system. Such smart systems eliminate or substantially reduce the risk of fraud (e.g. buddy punching time cards). In addition, smart badges can eliminate the need for payroll employees to calculate the time cards of employees and contractors. Additional productivity gains can also be achieved because employees and contractors no longer have to complete labor intensive manual time sheet calculations.

Most employee and contractor badges today employ a badge with a laminated photograph of the badge holder as part of the badge. The photograph is typically affixed to the badge and distributed to the badge holder. However, rarely if ever, are photos of visitors or guests taken and then attached to the badges. Typically, making unique badges for visitors, guests or contractors employed for a short period of time are not made due to the costs of generating a more permanent badge. However, it is the visitors, guests and short duration contractors who pose the highest risk to most organizations.

Therefore, a need exists for smart badge that can be reused, have a photo displayed of the badge holder, update or replace the badge as needed, changed the badge holder's credentials so that access to buildings on a campus are added or deleted, work areas within a building are added or deleted or the expiration of the badge is extended or shortened.

### SUMMARY

This invention provides a smart badge system for use with users to gain access to buildings or secure areas within a building. Such a smart badge may use an embedded processor with a memory area, a wireless transmitter/receiver or transceiver, at least one display area for showing a photograph of the badge holder or a designation of the badge holder, e.g. employee, contractor, guest or visitor. The smart badge also contains a power source such as an internal battery that may be periodically recharged to power the internal microprocessor, transceiver, memory and other components. The smart badge's battery may be recharged by placing the badge in a recharger where the badge has a physical connection to the recharging system or the badge may be recharged wirelessly by RF energy received by the badge's antenna. The smart badge may also include a light sensor so that when the badge it put into a wallet or purse and the light detector cannot detect light, the wireless transceiver can be disabled to prevent an unauthorized badge reader from reading potentially sensitive data stored in memory on the smart badge.

The smart badge can be created and assigned to a badge holder such that a photo of the badge holder is uploaded to the smart badge. Additional criteria regarding the badge holder may also be uploaded on the smart badge when the smart badge is created such as specific buildings or secure areas within specific buildings that the badge holder is authorized to access, the length of time before the smart badge expires, etc. If a badge holder needs to have their credentials updated or a plurality of badge holders need their credentials updated, an organization can perform such an update by changing the credentials in the smart badge database running on a computer network and the badges may be updated via a wired connection between the badge and the computer network or via a wireless connection such that the update occurs when the smart badges comes into close contact with a badge reader or otherwise connects to the organization's computer network via a wireless network protocol such as WiFi, Bluetooth, etc.

For additional sophistication, the smart badge may support the dynamic generation of a security code the changes on a periodic basis as an enhanced methodology to thwart fraudulent use of these badges in financial transactions or to access an organization's computer networks. The badge internally may comprise components such as a microprocessor connected to a viewable display powered by a battery where the processor is capable of generating security codes that are placed and stored in a memory location within the badge when the badge was created or the badge holder's credentials were updated. The badge can generate the security codes by encrypting certain data or by any methodology that generates keys that are exchanged with an organization's computer network such that the badge holder can be verified as an authorized user and access granted.

An alternative embodiment for the dynamic generation of security codes, the badge's microprocessor may recall from a memory storage area on the badge a security code from a list of encrypted security codes. The security code is then validated by the organization's computer network after verifying the authorization of the badge holder and allowing access.

Other systems, methods, features, and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### DETAILED DESCRIPTION OF THE DRAWINGS

The components in the figures are not necessarily to scale, emphasis being placed instead upon illustrating the principles of the invention. In the figures, like reference numerals designate corresponding parts throughout the different views.

FIG. 1 is a front view of a smart badge illustrating a flexible display for displaying a photo of the badge holder, a security code and a button.

FIG. 2 is a front view of a smart badge illustrating a flexible display for displaying a photo of the badge holder, a security code, keypad, hologram, light sensor and a button.

FIG. 3 is an internal view of a smart badge illustrating internal and external components laminated within the smart badge.

FIG. 4 is a flow chart illustrating changing the smart badge credentials and updating those credentials by a wireless connection.

FIG. 5 is a flow chart illustrating accessing location information stored in memory on the smart badge and displaying the location information on the smart badge's display.

FIG. 6 is a flow chart illustrating determining if the smart badge is expired and displaying an expired message on the smart badge display.

FIG. 7 is a flow chart illustrating limitations on the number of times the smart badge holder can access secured areas.

### DETAILED DESCRIPTION

This invention provides a re-useable, smart badge system for use with users to gain access to buildings or secure areas within a building. Such a smart badge may use an embedded processor with a memory area, a wireless transmitter/receiver or transceiver, at least one display area for showing a photograph of the badge holder. Additional displays embedded in the badge may include a designation of the badge holder, e.g. employee, contractor, guest or visitor, or a secure code that may be periodically generated as a pass code for the badge holder to access a secure area or a computer network. The smart badge may also contain a power source such as an internal battery that may power the internal microprocessor, transmitter/receiver/transceiver, memory, display(s), location sensor(s), light sensors and/or other components. The battery may be recharged by a direct connection of by a wireless recharging system.

In a simplistic form, a smart badge 100 may contain a magnetic stripe (not shown), a display 102, a hologram 104, a security code display 106 and a touch sensitive control button 108. The smart badge can be configured when created so that the badge holder's photo can be uploaded into memory embedded within the smart badge and shown on display 102. The hologram 104 may be used to prevent or reduce the likelihood that unauthorized individuals will create fraudulent badges. The security code may be displayed on a first display 102 or a second display 106. This security code can be used as a PIN code for use to access certain secure areas or to access a computer network. In an alternative embodiment, the display 102 may in a default mode display the smart badge holder's photograph.

When the touch sensitive control button 108 is pressed, the security code may be displayed on display 102 instead or on top of the badge holder's photograph. The touch sensitive control button 108 may be used to power off the smart badge when the holder is on vacation; power on the smart badge (based on the length of time the button is depressed); or to display the security code. By being able to power the smart badge on and off, the smart badge's battery life may be preserved.

FIG. 2 is a front view of a smart badge 200 illustrating a flexible display for displaying a photo of the badge holder, a security code display 204, a button 206, keypad 208, hologram 210, light sensor 212. Typically, the reusable identification badge is made out of a plastic material that can withstand some bending and impacts that would be part of daily use including various impacts from dropping. The implementation of a keypad 208 can support added security by requiring the input of a code before the security code is shown on display 204. In addition, periodically the smart badge may require the input of a pass code which if entered incorrectly will disable the functionality of the smart badge as well as show a warning message on display 202. Such heightened security features can prevent unauthorized access of secure areas should the smart badge be stolen or lost. Other security features on the badge may include a hologram 210. For even more enhanced security features, the badge may include the dynamic generation of a security code for use as a pass code for logging into a computer network.

For a smart badge 200, the badge may dynamically generate a pass code and show the pass code on display 202 or 204. The displays 202 or 204 may be incorporated into the badge's structure. For optimum results, these displays 202 or 204 may be flexible so that they will handle the stresses generated by the badge's use. Typically, the display 204 may show multiple digits/character readout. A touch sensitive control button 206 may be incorporated into the badge 200 so that whenever the touch sensitive control button 206 is selected, the pass code is shown on the display 202 or 204. If the badge has an internal battery, use of the touch sensitive control button 206 would preserve battery life as the display 204 could be off until the badge holder needs to generate the pass code. Also, the badge may generate a new pass code without any action taken on behalf of the badge holder based on the passage of a predetermined amount of time (e.g. a week, two weeks, a month, etc.) set by the badge issuer.

The smart badge may also include a light sensor 212 so that when the badge it put into a wallet or purse and the light detector cannot detect light, the wireless transceiver can be disabled to prevent an unauthorized badge reader from reading potentially sensitive data stored in memory on the smart badge. The light sensor 212 can be used to control whether the smart badge is on or off and whether the smart badge is capable of transmitting data regarding the badge holder that stored in memory on the badge to a badge reader. If the light sensor 212 senses a predetermined level of illumination, the badge will allow and support the transmission of badge data. If the light sensor 206 does not detect a predetermined level of illumination, the logic with the badge processor assumes that the badge is stored by the badge holder in the badge holder's wallet or purse and that any RF energy received by the badge that attempted to enable the badge to transmit data stored in memory on the badge is determined to be from a non-authorized source and the smart badge prevent the embedded transmitter from sending the badge data.

One of the short comings of preventing the badge's use by implementing a the light sensor 212 is that many users store their badges in their purse or wallet and only reluctantly attach them on their clothing or around their necks for easy viewing by other organization members or by security personnel. Thus, the badge holder may attempt to gain access to a building or secure area by merely waiving their wallet or purse in close proximity to the badge reader without actually removing the badge from their purse or wallet. Thus, implementation of the light sensor 212 could function as a mechanism for the badge issuer to enforce that badges must be worn by everyone. If the badge is placed in a wallet or purse, the badge's functionality is disabled. In an alternative embodiment, the badge may allow for building access even though the light sensor 212 fails to detect a certain level of illuminance, but would restrict the transmission of any of the badge holder's stored data or provide for the transmission of any computer access codes unless the badge detected a certain light level by the light sensor 212.

FIG. 3 is a view of the internal components contained within the smart badge. In its basic form, the smart badge 300 may have an internal antenna 302 that powers an integrated microprocessor/controller 304, and display 306. For additional functionality, the smart badge 300 may comprise some or all of the following components: a battery 308; memory storage area 310 which may be located within the microprocessor/controller 302 or external of the microprocessor/controller 302; a flexible display 306; a secondary display for secure codes (not shown); a touch sensitive button 312; a keypad 314; an RF antenna 302 for receiving power and/or sending and receiving data; an internal clock (not shown); a light sensor 316; a location sensor or GPS module 318; and a RF transceiver 320 (a separate transmitters and receiver can also be implemented on the badge).

In one embodiment, the smart badge 300 may be powered by RF energy transmitted by a badge reader. RF energy would power the badge when the badge is positioned in close proximity to the badge reader. When powered, the badge 300 would utilize a RF transmitter 320 to transmit information for the badge to be authenticated as authorized allowing the badge holder access to the building or secure area.

The flexible display 306 may be constructed using an e-paper type display so that the flexible display 306 is always on. In one embodiment, a pass code could be displayed along with the badge holder's photo on the display 306. In another embodiment, the pass code could be displayed on a second display and the badge holder's photo shown on display 306. If and when the badge expired, an expired message could be shown on the display 306, e.g. the text message “EXPIRED.” Another embodiment could display the pass code if the badge holder were to press the touch sensitive button 312 or input as password into the keypad 314.

In one embodiment, the smart badge may receive power to recharge or power up the smart badge's internal components integrated into the badge by radio frequency energy (“RF energy”) transmitted by a badge reader (not shown) or by recharging stations located within the building or secure workspace. In such a configuration, the smart badges operate using RF energy to power the internal badge's processor and related transmitter that transfers the badge's data such as information on the employee or contractor. However, because certain disreputable people, years ago learned that they could use a portable or stationary wireless terminal and once near an unsuspecting badge holder, could use a RF source to energize the smart badge and extract the badge's data to an unauthorized memory storage device. Later the stolen badge's data could be uploaded to a fake badge or used to gain unauthorized access to an organization's computer networks.

With the added functionality of an internal battery 308, the smart badge 300 is capable of autonomous functionality. In such an embodiment, the battery 308 would directly power the both the microprocessor 310, the RF transceiver 320, the light sensor 316, touch sensitive button 312 and keypad 314.

A location sensor or GPS module 318 may be integrated into the smart badge. The location sensor may be able to interface with badge readers so that localized transmitters assist the badge in triangulation of the badge's location relative to the transmitters. Such a location sensor system may provide a superior location system solution as most GPS signals degrade when the receiver is located within certain structures such as buildings and the GPS modules have a tendency to quickly degrade the battery life of the badge. Ideally, the location system should have at least three location signals for triangulation of the badge relative to a map stored in memory within the smart badge. Preloaded maps stored in a memory location on the badge may assist in showing the badge holder their location relative to the preloaded maps. Such functionality would be useful for individuals who are guests or visitors to a building or campus. This functionality may also be helpful to badge holders who work for an organization that has a large campus where badge holders may get lost looking for specific offices, conference rooms or even buildings within the campus.

In another embodiment, an embedded GPS module whose functionality is built into the microprocessor/controller 310 or whose functionality is located in a separate chip module 318, may assist a badge holder in locating their position relative to preloaded maps that are shown on the display 306. The keypad 314 may be used to cycle through different maps or to zoom in or zoom out allowing the badge holder to determine their precise location.

FIG. 4 is a flow chart illustrating changing the smart badge credentials and updating those credentials by a wireless connection. An organization that seeks to initialize a smart badge will select the badge 400. A photograph will be taken of the individual who will be assigned the badge and the photograph will be uploaded into the memory of the smart badge by means of a wireless connection or by a wired connection using physical contacts that are incorporated into the smart badge 402. The badge will then be uploaded with specific information regarding the badge holder 404. The smart badge is the created for the badge holder and presented to them 406.

Occasionally, logic in the smart badge may ascertain as to whether the badge holder's credentials need updating 408. In some instances, the control system supporting the smart badges may be accessed by an operator and a decision is made to update the badge holder's credentials. If the badge holder's credentials do not need updating, the smart badge is returned to the badge holder or in the alternative nothing is done 410. If the badge holder's credentials need updating, then the credentials are changed 412 and are uploaded to the smart badge via a wired or wireless network link 414.

Some of the criteria that may be updated on the badge are extensions of the validity of the badge. This may occur when the badge is issued for a relatively short period of time such as those provided to guests or visitors. The same may apply to contract workers who are issued badges that may last several days to several months. In such instances, the badge holder or the supervisor of the badge holder can call a badge holder network operator and authorize the extension of the badge. Once made, the credentials may be uploaded onto the badge by direct contact with a badge reader or other device. In some instances, the updating of credentials may be accomplished by a wireless link such as a WiFi, Bluetooth or some other wireless protocol standard.

FIG. 5 is a flow chart illustrating accessing location information stored in memory on the smart badge and displaying the location information on the smart badge's display. When a new smart badge is initiated 500, predetermined criteria may be uploaded on the badge 502 such as the photo of the badge holder, the department that they are assigned, the buildings or areas of access allowed by the badge system, name changes, telephone number changes, etc. The smart badge is then created with the badge holder's information uploaded into the memory location within the badge and the badge is provided to the badge holder 504.

When the smart badge holder queries the location of a building, conference room or office 506, the badge can retrieve a map from memory and display the map information on the badge's display. When coupled with a location module or GPS module, the badge holder's location is obtained 508 can be shown relative to the preloaded map 510 further assisting the badge holder with determining their current location relative to their desired location on the badge's display 512.

FIG. 6 is a flow chart illustrating determining if the smart badge is expired and displaying an expired message on the smart badge display. In most instances, once the badge is created and provided to the badge holder 600, the smart badge will show the badge holder's photograph in the badge's display 602. However, if the badge is assigned to a guest, visitor or contract worker, the badge credentials will have a badge life as one of the data fields. The badge's logic running on the badge's microprocessor can determine whether the badge's life has expired 604. If the badge has expired, the badge will display a “cancelled” or “expired” message on the badge's display 606. If the badge's credentials have not expired, the badge will continue to show the badge holder's photograph on the badge display 602.

FIG. 7 is a flow chart illustrating limitations on the number of times the smart badge holder can access secured areas. When a new smart badge is created and provided to a badge holder 700, the badge can be used to restrict or allow access to specific buildings or secured areas such as building floors, wings or specific rooms 702. The smart badge may store in the badge's memory all buildings, floor, rooms or specific areas as well as the time of arrival and time of departure of the badge holder 704. In certain circumstances, the badge may be configured to restrict the badge holder to accessing specific secured areas based on a specific number of times 706. If the badge was configured to limit the number of times a holder can access buildings or specific secure areas 706, then the badge determines whether or not the badge has reached the predetermined limits on the number of times the area can be accessed 710. If the limit has been reached, then the badge holder is denied access 710. If badge was not configured to limit the number of times the badge hold can access an area or if the badge was configured, but the number of times that the badge holder can access a specific area is less than the limit, then the badge holder will be allowed access 712.

While various embodiments of the invention have been described, it will be apparent to those of ordinary skill in the art that many more embodiments and implementations are possible that are within the scope of this invention.

What is claimed is:

1. An identification badge, comprising:
a microprocessor embedded in the identification badge;
a display embedded in the identification badge and electronically coupled to the microprocessor capable of displaying information regarding the badge holder; and
a power source embedded within the identification badge for supplying power to the microprocessor and display and input components.

2. The identification badge of claim 1, where the power source is an embedded battery.

3. The identification badge of claim 1, where the power source is RF energy received from a wireless network.

4. The identification badge of claim 1, further comprising input components electronically coupled to the power source and the microprocessor.

5. The identification badge of claim 4, where the input component is a touch sensitive button.

6. The identification badge of claim 4, where the input component is a keypad.

7. The identification badge of claim 4, where the input component is a light sensor.

8. The identification badge of claim 4, where the input component is a GPS module.

9. The identification badge of claim 4, where the input component is a location sensor.

10. The identification badge of claim 4, where the input component is a RF transmitter for supporting data transmissions to regarding the identification badge to a badge reader.

11. The identification badge of claim 4, where the input component is a RF receiver for supporting data received from a badge reader.

12. The identification badge of claim 4, where the input component is a RF transceiver for supporting the transmission and reception between the identification badge and an identification badge reader of the identification badge's data.

13. The identification badge of claim 4, where the input component is a touch sensitive button capable of powering the identification badge on.

14. The identification badge of claim 4, where the input component is a touch sensitive button capable of powering the identification badge off.

15. The identification badge of claim 1, where the information regarding the badge holder is a digital photo of the badge holder.

16. The identification badge of claim 1, further comprising a memory location contained within the microprocessor for storing information regarding the badge holder.

17. A method of creating and updating an identification badge comprising the steps of:
uploading a digital photograph of a badge holder to the identification badge;
entering criteria data on the badge holder into a memory location embedded in the identification badge; and
displaying the digital photograph on a display embedded in the identification badge.

18. The method of creating and updating the identification badge of claim 17 further comprising the step of determining if the criteria data needs updating and if so uploading new criteria data to the identification badge.

19. The method of creating and updating the identification badge of claim 17 where the uploading of new criteria data is accomplished by a wired connection.

20. The method of creating and updating the identification badge of claim 18 where the uploading of new criteria data is accomplished by a wireless connection.

21. The method of creating and updating the identification badge of claim 17 further comprising determining if the identification badge has expired and if so displaying a message on the display embedded in the identification badge.

22. The method of creating and updating the identification badge of claim 21 where message is the text “expired.”

23. The method of creating and updating the identification badge of claim 17 where the uploading of new criteria data includes a limitation on the number of times that the identification badge can access a secure area.

24. The method of creating and updating the identification badge of claim 21 further comprising determining whether the limitation on the number of times that the identification badge can access the secured area and if reached, denying the identification badge access to the secure area.

25. An identification badge location method comprising the steps of:
recalling map information from a memory location embedded on the identification badge;
receiving a plurality of location signals by a receiver embedded in the identification badge;
generating a badge location position relative to the map information; and
displaying the badge location position relative to the map information on a display embedded in the identification badge.

26. The identification badge location method of claim 25 where the receiving the plurality of location signals further comprises reception of the plurality of location signals from at least three RF signals sources.

27. A method for authenticating validity of a badge transaction, comprising the steps of:
generating an RF energy field by a badge reader;
powering an embedded microprocessor and a light sensor by receiving the RF energy by an embedded antenna connected to the microprocessor and the light sensor;
determining whether the embedded light sensor detects a predetermined light level and preventing the badge from transmitting badge data to the badge reader if the predetermined light level is not met and allowing the badge to transmit the badge data if the predetermined light level is met; and
obtaining a security code.
